(19) United States
(12) Patent Application Publication
(10) Pub. No.: US 2004/0037640 A1
(43) Pub. Date: Feb. 26, 2004

(54) Device for fastening tub to move drum type washing machine

(76) Inventors: Jea Kyum Kim, Kimhaei-shi Kyongsangnam-do (KR); Ho-Cheol Kwon, Changwon-shi (KR)

Correspondence Address: Song K Jung, McKenna Long & Aldridge, 1900 K Street NW, Washington, DC, 20006, US

(21) Appl. No.: 10/433,159

(22) PCT Filed: Nov. 27, 2001
(86) PCT No.: PCT/KR01/02049

(30) Foreign Application Priority Data
Dec. 1, 2000 (KR) 2000/72372

(51) Int. Cl. F16D 1/00

(52) U.S. Cl. 403/408.1

(57) ABSTRACT

A device for fastening a tub to move a drum type washing machine is disclosed, in which a main body of a fastening bolt having no thread is located in an inlet of a fastening boss formed in a tub so that the intensity of the fastening bolt is improved. Thus, the fastening bolt can bear stress generated by vibration of the tub and external impact when the drum type washing machine moves.

### TECHNICAL FIELD

The present invention relates to a drum washing machine, and more particularly, to a device for fastening a tub to move a drum type washing machine, in which a tub is fastened to a body during transportation of the drum washing machine for preventing the tub supported from the body by springs from shaking.

### BACKGROUND ART

In general, the washing machine is an appliance which removes dirt stuck to laundry by chemical decomposition and mechanical impact. As not only a total height of the appliance can be reduced compared to the pulsator washing machine of which inner tub rotates in a vertical position, but also a washing capacity can be increased more, and causes almost no problems, such as entangling of laundry, demand for the drum type washing machine increases day by day.

A related art structure of a drum washing machine will be explained, with reference to the attached drawing in detail. FIG. 1 illustrates a section of a related art drum washing machine, provided with a tub 2 supported by dampers 8 and springs 7 in a body 1, a cylindrical drum 3 rotatably fitted in the tub, and a driving part shaft coupled to the drum.

The driving part is provided with a rotor 4 and a stator 5 in rear of the tub 2, wherein the rotor 4 is directly coupled with a washing shaft 6 fitted to be rotatable with the drum for transmission of a driving force of the rotor to the drum 3 directly without a pulley or belt. There are a door 9 in a front face of the body opposite to an opening of the drum, and a gasket 10 between the door and the drum for sealing. In the foregoing drum washing machine, the rotation force of the rotor 4 is transmitted to the drum 3 through the washing shaft 6, and the washing is progressed as the laundry is lifted by a baffle 3a and dropped by gravity during rotation of the drum.

In the meantime, when the drum washing machine is transported, the tub 2 is shaken in up and down, and left and right directions because the tub 2 is supported by the springs 7 and the dampers 8, giving impacts to the driving part under the tub 2 or damage to the body 1. In order to prevent this, a device for fastening the tub 2 to the body in transportation is provided, which has a plurality of fastening bosses 11 on a rear surface of the tub and a plurality of fastening bolts 12 for passing through inserting holes in the body and coupled to the fastening bosses.

FIG. 2 illustrates a section of a key part of a related art fastening device for transportation of a drum washing machine, showing an enlarged view of the fastening bolt fastened to the fastening boss.

Referring to FIG. 2, since the fastening bolt 12 has an appropriate length of male thread part 12a on an outer circumference of an end thereof, and the fastening boss 11 has a female thread part 11a in an inner circumference thereof for engagement with the male thread part 12a, the fastening bolt and the fastening boss are fastened as the male thread part 12a and the female thread part 11a are engaged.

When the fastening bolt 12 is fastened to the fastening boss 11, a bolt holder 13, surrounding an outer circumference of the fastening bolt, protects the fastening bolt and maintains a gap between the tub and the body.

The impact occurred during transportation of the drum washing machine applies vibration to the tub 2, or to the fastening bolt 12 and the fastening boss 11, directly. In this instance, the vibration of the tub 2 acts as a bending moment or a shearing force to the fastening bolts 12 at a part the fastening boss 11 is in contact with the bolt holder 13. However, since the male thread part 12a on the fastening bolt 12 is exposed to outside of the fastening boss 11, there has been a problem in that the fastening bolt 12 becomes weak to strength.

That is, because the male thread part 12a on the fastening bolt is exposed outside of the fastening boss 11 in a state the fastening bolt 12 is engaged with the fastening boss 11 in the related art, there has been a stress concentration at a root part of the male thread part 12a in a part the fastening boss 11 is in contact with the bolt holder 13 due to the vibration or impact occurred during transportation of the drum washing machine, to cause bending in the root part of the male thread part 12a at which the stress is concentrated, with a high risk of breakage when the impact is excessive.

In other words, the root part of the male thread part of the fastening bolt at a point the fastening boss 11 and the bolt holder 13 are in contact acts as a notch that causes stress concentration, to weaken a strength of the fastening bolt against an impact to the tub.

Consequently, for solving the foregoing problem, it has been required to employ a thick fastening bolt with an adequate root diameter, or to provide a separate protection device.

### DISCLOSURE OF INVENTION

The object of the present invention devised for solving the foregoing problem lies on providing a device for fastening a tub to move a drum type washing machine which fastens a tub supported by springs during transportation of the drum washing machine for preventing damage or deformation caused by an external impact or vibration of the tub, particularly, by using fastening bolts and fastening bosses each with the present male thread part and female thread part, respectively.

For achieving the foregoing object, the present invention provides a device for fastening a tub to move a drum type washing machine having a tub for storing washing water, a drum rotatably fitted to the tub, a motor for rotating the drum, and a main body enclosing an outer shell of the tub, the device for fastening the tub to the main body during transportation of the drum washing machine includes a fastening bolt passed through the main body and fastened to the tub, and a fastening boss in rear of the tub for coupling with the fastening bolt, wherein the fastening bolt includes a head, a body extended from the head having no thread for insertion of a part thereof in the fastening boss, and a male thread extended from the body having male threads formed thereon, and the fastening boss includes a female thread having female threads formed therein to fit to the male thread on the fastening bolt, and an insertion hole at an entrance thereof for receiving a part of the body of the fastening bolt.

The body of the fastening bolt has an outside diameter greater than a root diameter of the male thread.

The insertion hole in the fastening boss has an inside diameter equal to or greater than an outside diameter of the female thread.

The fastening boss is formed as one unit with the tub.

The fastening device further includes a bolt holder on an outside of the fastening bolt fastened to the fastening boss to surround the outside circumference of the body of the fastening bolt, such that ends of the bolt holder and the fastening boss abut, and the point the bolt holder and the fastening boss abut is at a body region of the fastening bolt.

There is a rubber bushing in a form surrounding the bolt holder on an outside of a part passed through a body of the bolt holder, and there is a washer between the head of the fastening bolt and the rubber bushing.

### BRIEF DESCRIPTION OF DRAWINGS

FIG. 1 illustrates a section of a related art drum washing machine;

FIG. 2 illustrates a section of a key part of a related art device for fastening a tub to move a drum type washing machine;

FIG. 3a illustrates a section of a fastening bolt of a drum washing machine in accordance with a preferred embodiment of the present invention;

FIG. 3b illustrates a section of a fastening boss of a drum washing machine in accordance with a preferred embodiment of the present invention; and,

FIG. 4 illustrates a section of a device for fastening a tub to move a drum type washing machine in accordance with a preferred embodiment of the present invention.

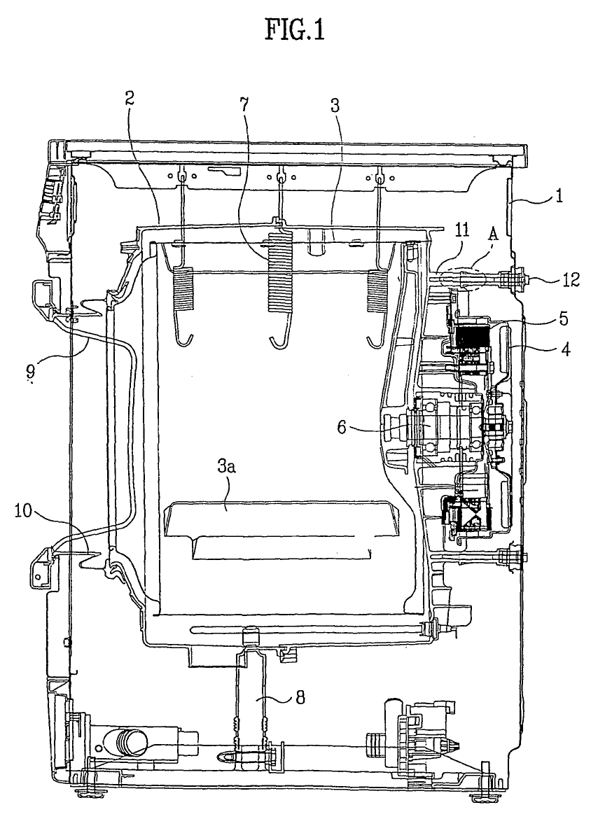

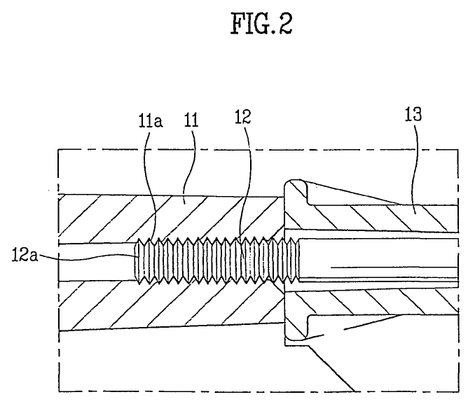

### BEST MODE FOR CARRYING OUT THE INVENTION

A device for fastening a tub to move a drum type washing machine in accordance with a preferred embodiment of the present invention will be explained, with reference to the attached drawings.

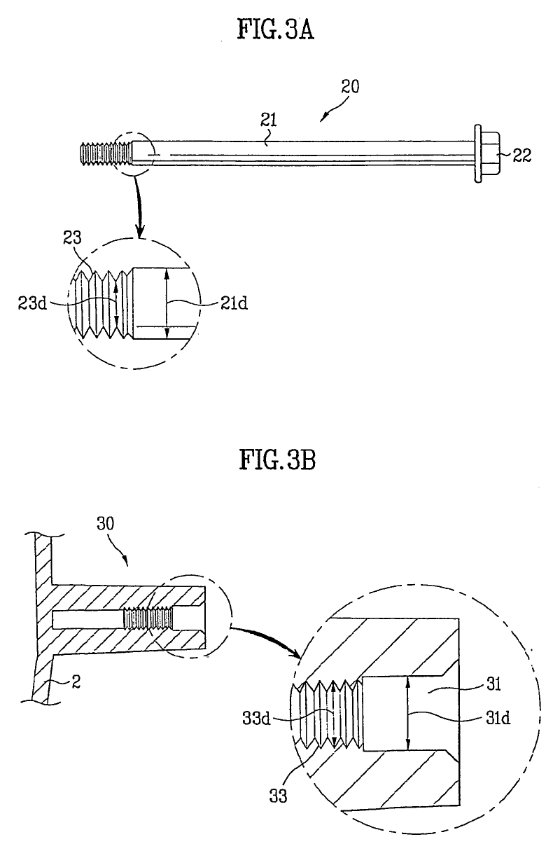

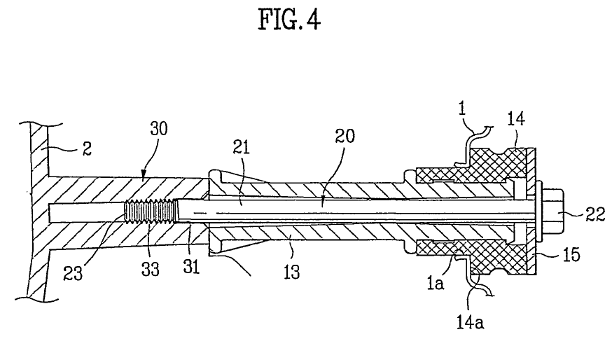

FIG. 3a illustrates a section of a fastening bolt of a drum washing machine in accordance with a preferred embodiment of the present invention, FIG. 3b illustrates a section of a fastening boss of a drum washing machine in accordance with a preferred embodiment of the present invention, and FIG. 4 illustrates a section of a device for fastening a tub to move a drum type washing machine in accordance with a preferred embodiment of the present invention.

Prior to starting explanation, parts related to a general drum washing machine system are the same with the previous description, of which explanation will be omitted, and explanation of the device for fastening a tub to move a drum type washing machine will be explained.

Referring to FIG. 3A, the fastening bolt 20 for transportation of a drum washing machine includes a body 21 with an outside diameter, a head 22 at one end of the body for being caught at a main body, and a male thread 23 at the other end of the body with a length. The outside diameter 21d of the body is greater than a root diameter 23d of the male thread 23.

In the meantime, referring to FIG. 3B, the fastening boss 30 of the drum washing machine in accordance with a preferred embodiment of the present invention is formed as one unit with the tub 2, and projected from rear of the tub 2 at a length toward the main body 1.

The fastening boss 30 has a female thread 33 in the middle of a length thereof for fitting to the male thread 23 of the fastening bolt 20, and an insertion hole 31 from one end of the female thread to an entrance for receiving a part of the body 21 of the fastening bolt when the fastening bolt 20 is coupled to the fastening boss 20. No thread is formed in an inside circumference of the insertion hole 31. The insertion hole has an inside diameter 31d at least equal to, or greater than an outside diameter 33d of the female thread 33 for insertion of the body of the fastening bolt.

Coupling of the foregoing fastening bolt and the fastening boss will be explained, in more detail.

Referring to FIG. 4, a device for fastening a tub to move a drum type washing machine in accordance with a preferred embodiment of the present invention includes the fastening boss 30 and the fastening bolt 20, and, in addition to these, a bolt holder 13 fitted to surround an outside circumference of the body 21 of the fastening bolt for maintaining a gap between the main body 1 and the tub 2, a rubber bushing 14 fitted to surround one end of an outside circumference of the bolt holder and be inserted in the insertion hole 1a in the body for absorbing an impact, and a washer 15 fitted between the rubber bushing and the head 22 of the fastening bolt.

The foregoing fastening device is assembled as follows.

At first, the bolt holder 13 is inserted in, and coupled with, the rubber bushing 14 the washer 15 is inserted through the body 21 until being caught at the head 22, and the rubber bushing 14 and the bolt holder 13 are inserted in the body 21 of the fastening bolt.

In this instance, not only the male thread 23 on the fastening bolt, but also a length of the body 21 of the fastening bolt the same or greater than a length of the insertion hole in the fastening boss pass through an end of the bolt holder 13.

Then, the fastening bolt having the bolt holder and the rubber bushing fitted thereto is pushed into the insertion hole 1a in rear of the main body until a step 14a of the rubber bushing 14 is caught at a rim of the insertion hole of the main body, and turns until an end of the bolt holder 13 comes to contact with the entrance of the fastening boss 30, thereby coupling the fastening bolt to the fastening boss.

In this instance, the male thread 33 in the fastening boss is engaged with the male thread 23 on the fastening bolt, and a part of the body 21 of the fastening bolt is received at the insertion hole 31 in the fastening boss, thereby fastening the tub 2 to the main body 1 firmly.

Thus, different from the related art, the device for fastening a tub to move a drum type washing machine of the present invention positions the body 21 of the fastening bolt at a point the fastening boss 30 is in contact with the bolt holder 13, that has been a part susceptible to impact and vibration during transportation, permitting to endure a load caused by an external impact or vibration of the tub during transportation of the drum washing machine.

That is, because the male thread of the fastening bolt is exposed to outside of the fastening boss, though deformation or breakage is occurred from a root part exposed nearest to the point the fastening boss and the bolt holder are in contact once a bending moment or a shearing force caused by vibration of the tub is applied thereto in the related art, the fastening device of the present invention can endure the shearing force or the bending moment well because the body of the fastening bolt is positioned at the point.

### INDUSTRIAL APPLICABILITY

The device for fastening a tub to move a drum type washing machine of the present invention employs a fastening bolt having a body, and a male thread at one end of the body, and a fastening boss having an insertion hole at an entrance for receiving a part of the body of the fastening bolt, and a female thread in an inside of the entrance for fitting to the male thread on the fastening bolt, for fastening the tub supported by springs and damper firmly during transportation.

Accordingly, a load from the tub is applied, not to the male thread, but to the body, the fastening bolt can endure impact and the like during transportation because no thread is formed on an outside circumference of the body, and an outside diameter of the body is greater than a root diameter of the male thread, that permit to secure an adequate strength.

At the end, different from the related art, the present invention permits to prevent the fastening bolt from being deformed or damaged by a load of the tub or impact during transportation even if a thick fastening bolt having adequate root diameter of the male thread is not used.

What is claimed is:

1. A device for fastening a tub to move a drum type washing machine having a tub for storing washing water, a drum rotatably fitted to the tub, a motor for rotating the drum, and a main body enclosing an outer shell of the tub, the fastening device for fastening the tub to the main body during transportation of the drum washing machine comprising:
a fastening bolt passed through the main body and fastened to the tub; and
a fastening boss in rear of the tub for coupling with the fastening bolt, wherein
the fastening bolt includes a head, a body extended from the head having no thread for insertion of a part thereof in the fastening boss, and a male thread extended from the body having male threads formed thereon, and
the fastening boss includes a female thread having female threads formed therein to fit to the male thread on the fastening bolt, and an insertion hole at an entrance thereof for receiving a part of the body of the fastening bolt.

2. The device as claimed in claim 1, wherein the body of the fastening bolt has an outside diameter greater than a root diameter of the male thread.

3. The device as claimed in claim 1, wherein the insertion hole in the fastening boss has an inside diameter equal to or greater than an outside diameter of the female thread.

4. The device as claimed in claim 1 or 3, wherein the fastening boss is formed as one unit with the tub.

5. The device as claimed in claim 1, further comprising a bolt holder on an outside of the fastening bolt fastened to the fastening boss to surround the outside circumference of the body of the fastening bolt, such that ends of the bolt holder and the fastening boss abut, and the point the bolt holder and the fastening boss abut is at a body region of the fastening bolt.

6. The device as claimed in claim 1, there is a rubber bushing in a form surrounding the bolt holder on an outside of a part passed through a body of the bolt holder, and there is a washer between the head of the fastening bolt and the rubber bushing.
